(19) United States
(12) Patent Application Publication
(10) Pub. No.: US 2018/0288084 A1
(43) Pub. Date: Oct. 4, 2018

(54) METHOD AND DEVICE FOR AUTOMATICALLY ESTABLISHING INTRUSION DETECTION MODEL BASED ON INDUSTRIAL CONTROL NETWORK

(71) Applicant: SHENYANG INSTITUTE OF AUTOMATION, CHINESE ACADEMY OF SCIENCES, Shenyang, Liaoning (CN)

(72) Inventors: Wenli SHANG, Liaoning (CN); Jianming ZHAO, Liaoning (CN); Ming WAN, Liaoning (CN); Xianda LIU, Liaoning (CN); Long YIN, Liaoning (CN); Peng ZENG, Liaoning (CN); Haibin YU, Liaoning (CN)

(73) Assignee: Shenyang Institute of Automation, Chinese Academy of Sciences, Shenyang, Liaoning (CN)

(21) Appl. No.: 15/572,643

(22) PCT Filed: Apr. 17, 2017
(86) PCT No.: PCT/CN2017/080716

§ 371 Date: Nov. 8, 2017

(30) Foreign Application Priority Data
Dec. 15, 2016 (CN) 201611162117.5

(51) Int. Cl. H04L 29/06; G06K 9/62

(52) U.S. Cl. CPC H04L 63/1425; H04L 63/1416; G06K 9/6269; G06K 9/6256; G06K 9/6229

(57) ABSTRACT

The present application discloses a method for automatically establishing an intrusion detection model based on an industrial control network, including: judging whether a first intrusion detection model meets preset detection requirements, and extracting communication behavior traffic data in real time if not; setting a training data set and a test date set according to the communication behavior traffic data; establishing an initial intrusion detection model according to the training data set; and testing the initial intrusion detection model using the test date set, and establishing a second intrusion detection model meeting the preset detection requirements according to the test result. The second intrusion detection model has high detection accuracy, thereby increasing intrusion detection rate of abnormal behavior and reducing false positive rate and false negative rate.

### FIELD OF THE INVENTION

The present application relates to a method and device for automatically establishing an intrusion detection model based on an industrial control network, which belongs to the technical field of industrial control network security protection.

### BACKGROUND OF THE INVENTION

Industrial control systems (hereinafter referred to as ICS) are automatic control systems composed of computer equipment and industrial process control components, which are widely applied to industry, energy, transportation, petroleum chemistry and other basic fields. Because ICSs are connected to enterprise networks and Internet more and more to form an open network environment, the network security protection technology of ICS has great significance for guaranteeing the safe, reliable and stable operation of ICS.

At present, the network security of ICS is guaranteed mainly using an intrusion detection technology. Intrusion detection technology is an active security protection technology, which can detect an abnormal behavior operation by extracting communication traffic data features in ICS and analyze same, and perform interception, warning, system recovery and other operations before abnormal behavior is generated.

In the prior art, an intrusion detection model is established according to network communication traffic data, and then intrusion detection of abnormal behavior is conducted always using the intrusion detection model. However, because industrial communication is conducted in real time and communication behavior traffic data are continuously changed, intrusion detection in the prior art has relatively high false positive rate and false negative rate.

### SUMMARY OF THE INVENTION

According to one aspect of the present application, a method for automatically establishing an intrusion detection model based on an industrial control network is provided. The intrusion detection model obtained by the method has high detection accuracy, thereby increasing intrusion detection rate of abnormal behavior and reducing false positive rate and false negative rate.

A method for automatically establishing an intrusion detection model based on an industrial control network, comprising:

judging whether a first intrusion detection model meets preset detection requirements, and extracting communication behavior traffic data in real time if not;

setting a training data set and a test date set according to the communication behavior traffic data;

establishing an initial intrusion detection model according to the training data set; and

testing the initial intrusion detection model using the test date set, and establishing a second intrusion detection model meeting the preset detection requirements according to the test result.

Wherein the preset detection requirements comprise a detection rate threshold, a detection time threshold, a false positive rate threshold and/or a false negative rate threshold.

Further, after the step of extracting communication behavior traffic data in real time, the method further comprises:

conducting attribute reduction on the communication behavior traffic data extracted in real time.

Attribute reduction is conducted on the communication behavior traffic data extracted in real time, specifically:

attribute reduction is conducted on the communication behavior traffic data extracted in real time using the RST.

According to one aspect of the present application, a device for automatically establishing an intrusion detection model based on an industrial control network is provided. The device comprises a judgment module, an extraction module, a setting module, a first establishment module and a second establishment module,

wherein the judgment module is used for judging whether a first intrusion detection model meets preset detection requirements, and triggering the extraction module if not;

the extraction module is used for extracting communication behavior traffic data in real time after being triggered by the judgment module;

the setting module is used for setting a training data set and a test date set according to the communication behavior traffic data extracted by the extraction module;

the first establishment module is used for establishing an initial intrusion detection model according to the training data set which is set by the setting module; and

the second establishment module is used for testing the initial intrusion detection model established by the first establishment module using the test date set which is set by the setting module, and establishing a second intrusion detection model meeting the preset detection requirements according to the test result.

The preset detection requirements comprise a detection rate threshold, a detection time threshold, a false positive rate threshold and/or a false negative rate threshold.

Further, the device also comprises an attribute reduction module, used for conducting attribute reduction on the communication behavior traffic data extracted by the extraction module in real time;

accordingly, the setting module is used for setting a training data set and a test date set according to the communication behavior traffic data reduced by the attribute reduction module.

Specifically, the attribute reduction module conducts attribute reduction on communication traffic data features extracted in real time using the RST.

The present application has the beneficial effects including:

1) In the present application, it is judged whether a first intrusion detection model meets preset detection conditions, if the first intrusion detection model does not meet the preset detection conditions, communication behavior traffic data are extracted in real time, a training data set and a test date set are set according to the communication behavior traffic data extracted in real time, an initial intrusion detection model is established according to the training data set, the initial intrusion detection model is tested using the test date set, and a second intrusion detection model meeting preset detection requirements is established according to the test result. Compared with the prior art using a fixed first intrusion detection model to conduct intrusion detection, the second intrusion detection model obtained by embodiments of the present invention has high detection accuracy, thereby increasing the intrusion detection rate of abnormal behavior and reducing false positive rate and false negative rate; and

2) Further, in the present application, attribute reduction is conducted on the communication behavior traffic data extracted in real time using the RST, thereby reducing the complexity of the second intrusion detection model, further improving the detection accuracy of the second intrusion detection model and saving detection time.

### BRIEF DESCRIPTION OF THE DRAWINGS

FIG. 1 is a flow diagram of a method for automatically establishing an intrusion detection model based on an industrial control network; and

FIG. 2 is a structural schematic diagram of a device for automatically establishing an intrusion detection model based on an industrial control network.

### DETAILED DESCRIPTION OF THE EMBODIMENTS

The present application is further described in detail in combination with embodiments. However, the present application is only limited to these embodiments.

### Embodiment 1

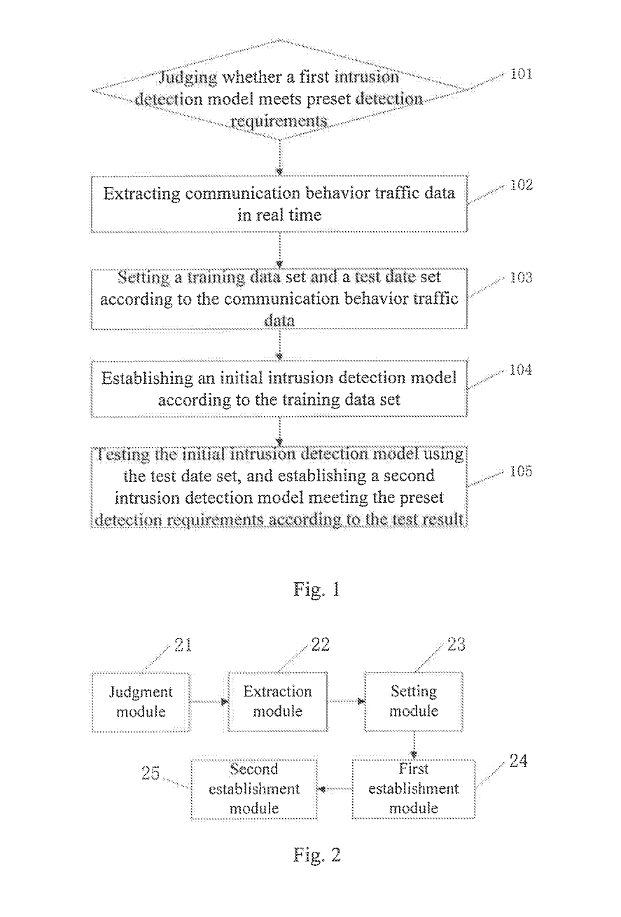

See FIG. 1, an embodiment of the present invention provides a method for automatically establishing an intrusion detection model based on an industrial control network, the method comprising:

101. Judging whether a first intrusion detection model meets preset detection requirements, and if so, keeping an application of a current intrusion detection model; otherwise, executing step 102;

specifically, the intrusion detection model is a decision discriminant function for communication behavior constructed by training and testing a network traffic data set using a support vector machine (SVM) algorithm:

$$f ( x ) = sign ( {\sum }_{i = 1}^{N} {α}_{i}^{*} {y}_{i} K ( x \cdot {x}_{i} ) + {b}^{*} )$$

where x represents a communication behavior data sample on which detection discriminant is required to be conducted, xᵢ,yᵢ (i=1, 2, . . . N) represents a communication behavior sample of the training data set, and α*ᵢ and b* represent coefficients, which are obtained by solving the optimization problem of convex quadratic programming. When the decision function ƒ(x) is +1, the communication behavior is judged as normal communication behavior, and when the decision function is −1, the communication behavior is judged as abnormal attack behavior. N represents the number of samples; K( ) represents an adopted nonlinear mapping function, and sign represents a sign function.

The preset detection requirements comprise one or more of a detection rate threshold, a detection time threshold, a false positive rate threshold and a false negative rate threshold, which may be selected according to actual conditions, and may not be specifically limited in embodiments of the present invention.

102. Extracting communication behavior traffic data in real time;

the communication behavior traffic data extracted in real time in embodiments of the present invention may be normal communication behavior traffic data, and may be communication behavior traffic data including abnormal attack behavior as well. According to judgment in step 101, when a new intrusion detection model is required to be studied and updated, transmission traffic of the industrial control network is captured using wireshark, to acquire communication behavior traffic data in real time, and process a data packet file according to requirements of input data of the detection model (for example, input data format, data standardization), and a communication behavior sample data set is established in real time by designing a read and write program for a storage file, to train and test the new model.

Abnormal behavior in the embodiment of the present invention comprises illegal connection, unauthorized access, data modification or destruction, and other various destructive behavior.

103. Setting a training data set and a test date set according to the communication behavior traffic data: constructing data sets (the training data set and the test date set) for communication behavior detection according to detection features by acquiring communication traffic data of a Modbus/TCP industrial control network, for example, features of difference between communication behavior operation modes are reflected using an IP address, an MAC address, a port number, a protocol identifier, a function code, a data address, an IP packet header length, a unit identifier and a number of abnormal function codes generated in unit time; and further, constructing a knowledge representation system required to be reduced, reducing corresponding intrusion detection features using a rough sets theory method, establishing a data sample set of reduction attributes according to the reduced detection features, and setting a training date set and a test date set of the intrusion detection model in combination with actual communication behavior categories and the size of the sample set.

104. Establishing an initial intrusion detection model according to the above-mentioned training data set;

the method for establishing the initial detection model comprises: establishing a training sample set and a test sample set of communication behavior data according to reduction features using a support vector machine (SVM) algorithm, for example, using valid detection feature data information kept after reduction when some redundant detection features such as the MAC address, the unit identifier and the like are deleted; and obtaining a detection model for industrial communication behavior by training a model of the training sample set, conducting prediction discriminant and analysis on the test sample set, then adjusting detection model parameters and optimizing training, and establishing an intrusion detection model meeting requirements finally. Specifically, the initial intrusion detection model is that according to the training sample set, by setting penalty factor parameters and kernel function parameters, the optimization problem of convex quadratic programming is solved, and a decision function for communication behavior discriminant is established according to the obtained Lagrangian factor parameters.

The initial intrusion detection model is a decision discriminant function, where x represents the test sample set, and xᵢ,yᵢ (i=1, 2, . . . N) represents the training sample set. When the decision function ƒ(x) is +1, the communication behavior is judged as normal communication behavior, and when the decision function is −1, the communication behavior is judged as abnormal attack behavior.

105. Testing the above-mentioned initial intrusion detection model using the test date set, and establishing a second intrusion detection model meeting the preset detection requirements according to the test result.

Through the set communication behavior detection requirements, if the detection performance of the second intrusion detection model (each item of the detection requirements) is less than a set value, the model is studied and trained again, and feature reduction is conducted on the real-time network communication data using the RST algorithm, to update the traffic data information for communication behavior detection. Attribute reduction is that a decision table DT is constructed first according to a communication traffic data set, a reduction kernel of a detection feature C relative to a decision attribute D is computed, the attribute importance of the detection feature is computed according to a positive region, a detection feature with the maximum attribute importance is selected, a detection feature combination is added, a positive region of the new feature combination for classifying data sample categories is computed; if the positive region is identical to the positive region of the initial detection feature C for classifying D, a reduction feature B is output, otherwise, other features are added according to the attribute importance and classification conditions are computed, to obtain a reduction attribute set of the detection features. Finally, parameter optimization training is conducted on the SVM detection model, to establish an attack operation detection model meeting detection performance requirements.

The second intrusion detection model is a decision discriminant function, where x represents a test sample set and xᵢ,yᵢ (i=1, 2, . . . N) represents a training sample set. When decision function ƒ(x) is +1, the communication behavior is judged as normal communication behavior, and when the decision function is −1, the communication behavior is judged as abnormal attack behavior.

In the prior art, intrusion detection of abnormal behavior is conducted using the fixed established first intrusion detection model. Because industrial communication occurs in real time, and the communication behavior traffic data thereof are continuously changed, the detection accuracy is not high by conducting intrusion detection using the fixed first intrusion detection model, so that the timeliness requirements of industrial communication cannot be met. While in embodiments of the present invention, it is judged whether a first intrusion detection model meets preset detection requirements, if the first intrusion detection model does not meet the preset detection requirements, communication behavior traffic data are extracted in real time, an initial intrusion detection model is re-established according to these communication behavior traffic data, the initial intrusion detection model is corrected to obtain a second intrusion detection model meeting preset detection requirements, and intrusion detection of abnormal behavior is conducted using the second intrusion detection model, thereby greatly increasing intrusion detection rate, and reducing false positive rate and false negative rate of intrusion detection.

Further, after step 102, the method further comprises:

conducting attribute reduction on the communication behavior traffic data extracted in real time.

Specifically, attribute reduction is conducted on communication traffic data features extracted in real time based on the rough sets theory (hereinafter referred to as RST).

More specifically, attribute reduction is conducted on the communication traffic data features extracted in real time using a decision table based on the PawLak attribute importance of RST.

In an intrusion detection system, communication behavior traffic data amount is huge, and attributes are numerous, wherein some attributes have little effect on the intrusion detection result, and even some attributes have no effect on the intrusion detection result. In this way, intrusion detection result of abnormal behavior may be misled, thereby not only reducing the intrusion detection rate of abnormal behavior, but also affecting the requirements of real-time communication of industrial control networks.

RST is suitable for a mathematical tool for processing ambiguity and uncertainty, and is mainly used for discovering modes and laws from incomplete data sets. At present, RST is widely applied to chemical industry, medical diagnosis, process control, commercial economy and other fields.

In embodiments of the present invention, RST is applied to the present invention for the first time, attribute reduction is conducted on the communication behavior traffic data extracted in real time using RST, and useless attributes are separated, so that the detection process will focus on key data attributes, thereby greatly reducing the complexity of the intrusion detection model, improving the detection accuracy of the intrusion detection model, and saving detection time. However, embodiments of the present invention are not limited to conduct attribute reduction using RST, and genetic algorithm, dynamic reduction and other reduction manners capable of achieving attribute reduction effects may also be used as well.

In embodiments of the present invention, it is judged whether a first intrusion detection model meets preset detection conditions, if the first intrusion detection model does not meet the preset detection conditions, communication behavior traffic data are extracted in real time, a training data set and a test date set are set according to the communication behavior traffic data extracted in real time, an initial intrusion detection model is established according to the training data set, the initial intrusion detection model is tested using the test date set, and a second intrusion detection model meeting preset detection requirements is established according to the test result. Compared with the prior art using a fixed first intrusion detection model to conduct intrusion detection, the second intrusion detection model obtained by embodiments of the present invention has high detection accuracy, thereby increasing intrusion detection rate of abnormal behavior and reducing false positive rate and false negative rate; and further, in embodiments of the present invention, attribute reduction is conducted on the communication behavior traffic data extracted in real time using the RST, thereby reducing the complexity of the second intrusion detection model, further improving the detection accuracy of the second intrusion detection model and saving detection time.

See FIG. 2, embodiments of the present invention provide a device for automatically establishing an intrusion detection model based on an industrial control network. The device comprises a judgment module 21, an extraction module 22, a setting module 23, a first establishment module 24 and a second establishment module 25,

wherein the judgment module 21 is used for judging whether a first intrusion detection model meets preset detection requirements, and triggering the extraction module 22 if not;

specifically, the preset detection requirements comprise one or more of a detection rate threshold, a detection time threshold, a false positive rate threshold and a false negative rate threshold, which may be selected according to actual conditions, and may not be specifically limited in embodiments of the present invention.

The extraction module 22 is used for extracting communication behavior traffic data in real time after being triggered by the judgment module 21;

the communication behavior traffic data extracted in real time in embodiments of the present invention may be normal communication behavior traffic data, and may be communication behavior traffic data including abnormal attack behavior.

The setting module 23 is used for setting a training data set and a test date set according to the communication behavior traffic data extracted by the extraction module 22;

the first establishment module 24 is used for establishing an initial intrusion detection model according to the training data set which is set by the setting module 23; and

the second establishment module 25 is used for testing the initial intrusion detection model established by the first establishment module 24 using the test date set which is set by the setting module 23, and establishing a second intrusion detection model meeting the preset detection requirements according to the test result.

Further, an embodiment of the present invention further comprises an attribute reduction module used for conducting attribute reduction on the communication behavior traffic data extracted by the extraction module 22 in real time;

accordingly, the setting module 23 is used for setting a training data set and a test date set according to the communication behavior traffic data reduced by the attribute reduction module.

Specifically, the attribute reduction module uses the decision table based on the PawLak attribute importance of RST to conduct attribute reduction on the communication traffic data features extracted in real time.

In embodiments of the present invention, it is judged whether a first intrusion detection model meets preset detection conditions, if the first intrusion detection model does not meet the preset detection conditions, communication behavior traffic data are extracted in real time, a training data set and a test date set are set according to the communication behavior traffic data extracted in real time, an initial intrusion detection model is established according to the training data set, the initial intrusion detection model is tested using the test date set, and a second intrusion detection model meeting preset detection requirements is established according to the test result. Compared with the prior art using a fixed first intrusion detection model to conduct intrusion detection, the second intrusion detection model obtained by embodiments of the present invention has high detection accuracy, thereby increasing intrusion detection rate of abnormal behavior and reducing false positive rate and false negative rate; and further, in embodiments of the present invention, attribute reduction is conducted on the communication behavior traffic data extracted in real time using the RST, thereby reducing the complexity of the second intrusion detection model, further improving the detection accuracy of the second intrusion detection model and saving detection time.

The above-mentioned embodiments are only several embodiments of the present application, and are not intended to limit the present application in any form. Although the present application discloses the above-mentioned embodiments through preferred embodiments, the above-mentioned embodiments are not intended to limit the present application. For those skilled in the art, various alterations or modifications made using the above disclosed technical content without departing from the spirit of the technical solution of the present application are all equal to equivalent implementation cases, and all belong to the scope of the technical solution.

1. A method for automatically establishing an intrusion detection model based on an industrial control network, which comprises the following steps:
judging whether a first intrusion detection model meets preset detection requirements, if not extracting communication behavior traffic data in real time;
setting a training data set and a test date set according to the communication behavior traffic data;
establishing an initial intrusion detection model according to the training data set; and
testing the initial intrusion detection model using the test date set, and establishing a second intrusion detection model meeting the preset detection requirements according to the test result.

2. The method according to claim 1, wherein the preset detection requirements comprise a detection rate threshold, a detection time threshold, a false positive rate threshold and/or a false negative rate threshold.

3. The method according to claim 1, wherein after the step of extracting communication behavior traffic data in real time, the method further comprises:
conducting attribute reduction on the communication behavior traffic data extracted in real time.

4. The method according to claim 3, wherein attribute reduction is conducted on the communication behavior traffic data extracted in real time, specifically:
attribute reduction is conducted on the communication behavior traffic data extracted in real time using RST.

5. A device for automatically establishing an intrusion detection model based on an industrial control network, which comprises a judgment module, an extraction module, a setting module, a first establishment module and a second establishment module,
wherein the judgment module is used for judging whether a first intrusion detection model meets preset detection requirements, and triggering the extraction module if not;
the extraction module is used for extracting communication behavior traffic data in real time after being triggered by the judgment module;
the setting module is used for setting a training data set and a test date set according to the communication behavior traffic data extracted by the extraction module;
the first establishment module is used for establishing an initial intrusion detection model according to the training data set which is set by the setting module; and
the second establishment module is used for testing the initial intrusion detection model using the test date set which is set by the setting module, and establishing a second intrusion detection model meeting the preset detection requirements according to the test result.

6. The device according to claim 5, wherein the preset detection requirements comprise a detection rate threshold, a detection time threshold, a false positive rate threshold and/or a false negative rate threshold.

7. The device according to claim 5, characterized by further comprising an attribute reduction module used for conducting attribute reduction on the communication behavior traffic data extracted by the extraction module in real time;
accordingly, the setting module is used for setting a training data set and a test date set according to the communication behavior traffic data reduced by the attribute reduction module.

8. The device according to claim 7, wherein the attribute reduction module conducts attribute reduction on communication traffic data features extracted in real time using RST.
